(19) United States
(12) Patent Application Publication
(10) Pub. No.: US 2026/0245392 A1
(43) Pub. Date: Aug. 20, 2026

(54) ADAPTIVE FRAMEWORK FOR AUTOMATED ARTIFICIAL INTELLIGENCE PROCESS

(71) Applicant: CIBC, Toronto (CA)

(72) Inventors: Ozge YELOGLU, Toronto (CA); Arqam SHAIKH, Toronto (CA); Jason MACWAN, Toronto (CA); Anton SHESTERNEV, Toronto (CA); Mahsa ROUZBAHMAN, Toronto (CA); Aditya ANNE, Toronto (CA)

(21) Appl. No.: 19/653,766

(22) Filed: Apr. 21, 2026

Related U.S. Application Data
(60) Provisional application No. 63/929,944, filed on Dec. 3, 2025.

(51) Int. Cl. G06V 30/19; G06F 30/20; G06F 111/08

(52) U.S. Cl. CPC G06V 30/1916; G06F 30/20; G06F 2111/08

(57) ABSTRACT

A method and system for artificial intelligence (AI) automation are disclosed. An AI model is used to determine a confidence level that an AI action on an object, such as AI document processing, meets a pre-defined target of processing accuracy. If the confidence level is above a confidence threshold, the AI action is adopted; if not, a manual action may be performed instead. Upon automatically processing N documents, a sub-population M of N documents is verified. A Monte Carlo simulation is usable to provide an overall confidence threshold including a statistical estimation of the accuracy of non-verified AI actions.

### REFERENCE TO RELATED APPLICATION

This application claims priority to U.S. Provisional Patent Application No. 63/929,944 entitled “Adaptive Framework for Automated AI Processing”, filed on Dec. 3, 2025, and incorporated herein by reference in its entirety.

### TECHNICAL FIELD

The present disclosure relates to governance and quality control of automated decision systems, and in particular to systems and methods for automatic document data extraction, fraud detection, healthcare diagnostics, content moderation, quality assurance, and other tasks that may be automated using artificial intelligence (AI).

### BACKGROUND

Intelligent document processing (IDP) automatically reads and extracts key information from documents presented by scans, PDFs, and web forms by using artificial intelligence (AI) models to perform text recognition and document layout analysis. Computer vision may be integrated with natural language processing to automatically classify and triage documents, extract document maps and key-value pairs, and obtain structured versions of documents.

Ensuring veracity of the automated document processing output is a challenging task, especially in highly regulated industry sectors such as banking. To keep control of the accuracy of processed documents, a verifiable end-to-end control framework is required. Because an undetected error in automatic ingesting of financial documents and forms can be very costly, automatic document processing needs to operate in a verifiable manner and at a high level of fidelity of output data. To that end, manual verification may be used; yet manual document verification is resource-intensive, error-prone, and not easily scalable. Existing automation solutions often lack robust oversight mechanisms, leading to potential declines in model accuracy and confidence over time which may remain unnoticed long enough to question the fidelity of a large volume of documents that have been already processed.

### BRIEF DESCRIPTION OF THE DRAWINGS

Exemplary embodiments will now be described in conjunction with the drawings, in which:

FIG. 1 is a flowchart of deployment phases of intelligent document processing (IDP) with adjustable confidence thresholds in accordance with this disclosure;

FIG. 2 is a block diagram of a document processing system implementing the IDP of FIG. 1;

FIG. 3 is an error rate estimation flowchart in accordance with this disclosure;

FIG. 4 is a flowchart of a method for document processing using adaptive thresholds and the error rate estimation of FIG. 3;

FIG. 5 is a functional block diagram of an example document processing system of this disclosure;

FIG. 6 is a schematic diagram of an example computing system usable to implement methods disclosed herein; and

FIG. 7 is a schematic diagram of an example networking environment of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering but rather are intended to distinguish one element from another, unless explicitly stated. Similarly, sequential ordering of method steps does not imply a sequential order of their execution, unless explicitly stated.

An Intelligent Document Processing (IDP) system may rely on confidence-based routing to define manner in which a document is to be processed. The confidence-based routing may use a confidence score provided by an artificial intelligence (AI) model, e.g. a model performing actual document data extraction or classification. The AI model assigns a confidence score to the extracted data or decision. When the confidence score is at or above a threshold, the results of automatic processing are accepted, and the document may be processed further in automatic regime with a minimal human oversight. When the confidence score is lower than the threshold, indicating an elevated uncertainty or a higher risk of error, the document is routed to a human reviewer (human-in-the-loop, or HITL) for processing, validation, and/or correction. This approach ensures that only documents with a high likelihood of accurate processing are processed automatically, while ambiguous or complex documents receive human attention, thereby improving overall accuracy of the results obtained and reducing operational risks.

When more documents are assigned to automated processing, more human verification is generally required to maintain the veracity level; however, the human review of high-risk documents is not easily scalable. On the other hand, reducing or omitting human verification may result in raised levels of incorrect automated data extraction. In cases where only a sub-population of the automatically processed documents is manually verified, the unverified automatically processed documents may run the risk of including incorrect data.

In document processing architecture disclosed herein, the dilemma between high rate of document processing affordable by automation on one hand, and a required high degree of control of fidelity of the obtained data on the other is resolved by separating the incoming flow of documents into two paths. One path, selected when a confidence score by the processing AI model is lower than a threshold, is HITL path which involves human processing and optional human verification. The other path, selected when a confidence score by the processing AI model is equal to or above the threshold, is an automated path with only partial human verification.

The partial human verification may operate as follows. Upon automatically processing N documents, a sub-population of M processed documents out of the N processed documents (M<N) is manually verified for correctness. The confidence level threshold may then be adjusted depending on whether an incorrectly processed document has been identified among the verified M documents. In this way, all N documents need not be manually verified, which promotes scalability, while a robust method of controlling the confidence level threshold provides a high degree of fidelity and accountability.

Once a pool of documents is processed either manually or automatically, depending on the determined confidence level in relation to the threshold as explained above, an overall error rate in the pool of processed documents may be computed based on the verification of all manually processed documents and the verification of M automatically processed documents (out of the N documents). In accordance with this disclosure, this overall error rate may be estimated based on a weighted average of three specific error rates: an error rate of the verified manually processed documents, an error rate of the verified M documents, and an estimated error rate of non-verified N-M automatically processed documents. The latter, i.e. the error rate of N-M non-verified automatically processed documents, may be evaluated statistically by running a Monte Carlo re-sampling simulation. The confidence intervals may then be translated into a system-wide single point accuracy estimate for the composite key performance indicator or KPI. The threshold adjustment, performed based on the currently achieved KPI, may be optionally logged in an immutable database for traceability.

In accordance with the present disclosure, there is provided a method for document processing. The method comprises using an AI model to determine a confidence level that a document, when processed automatically, will meet a pre-defined target of processing accuracy. If the determined confidence level is equal to or above a confidence threshold, automatic processing of the document is adopted. Upon automatically processing N documents, M automatically processed documents out of the N automatically processed documents are verified manually (M<N). The confidence threshold is adjusted depending on whether an incorrectly processed document has been identified among the verified M documents. Upon determining that the confidence level is below the confidence threshold, the document may be processed manually.

A pool of documents may be processed in the above manner, manually or automatically, depending on the determined confidence level in relation to the confidence threshold. An error rate in the pool of processed documents may then be estimated based on the verification of all manually processed documents and the M automatically processed documents. The error rate may be estimated based on a weighted average of an error rate of the verified manually processed documents, an error rate of the verified M automatically processed documents, and an error rate of non-verified N-M automatically processed documents, which may be estimated statistically by running a Monte Carlo simulation.

The method may further include statistically determining a probability that a next document processed after adjusting the confidence threshold will not meet the pre-defined target of processing accuracy, and/or reverting to processing all documents manually when a number K of incorrectly processed documents among the M verified documents exceeds a pre-defined threshold. The confidence threshold may be adjusted without re-training the AI model. Each confidence threshold adjustment may be logged in an immutable database. In some embodiments, he determined confidence level may be based, at least in part, on a quality metric associated with optical character recognition (OCR) of the document.

In accordance with the present disclosure, there is provided a document processing computing system comprising a confidence calibration service comprising an artificial intelligence (AI) model for determining a confidence level that a document, when processed automatically, will meet a pre-defined target of processing accuracy. A routing orchestrator is provided for adopting automatic processing of the document if the determined confidence level is equal to or above a confidence threshold. A quality assurance workbench may be provided for a manual verification of M automatically processed documents out of N automatically processed documents, where M<N. A threshold manager is provided for adjusting the confidence threshold depending on whether an incorrectly processed document has been identified among the verified M documents. In some embodiments, the quality assurance workbench is configured to select manual processing of the document upon determining that the confidence level is below the confidence threshold.

The system may further include a sampling engine for selecting the M out of the N automatically processed documents, and a metrics engine for estimating, upon processing a pool of documents either manually or automatically depending on the determined confidence level in relation to the confidence threshold, an error rate in the pool of processed documents based on the verification of all manually processed documents and the M automatically processed documents. The error rate may be estimated based on a weighted average of an error rate of the verified manually processed documents, an error rate of the verified M automatically processed documents, and an estimated error rate of non-verified N-M automatically processed documents. The system may include a Monte Carlo simulation engine for determining the error rate of the N-M non-verified automatically processed documents. The Monte Carlo simulation engine may be configured to statistically determine a probability that a next document processed after adjusting the confidence threshold will still not meet the pre-defined target of processing accuracy.

In some embodiments, the system further includes a logger for logging each confidence threshold adjustment by the threshold manager in an immutable database. To provide extra stability of document processing, the system may be configured to revert to processing all documents manually when a number K of incorrectly processed documents among the M verified automatically processed documents exceeds a pre-defined threshold for the number K. In some embodiments, the system may be configured to adjust the confidence threshold without having to re-train the AI model.

In accordance with the present disclosure, there is further provided an automatic decision-making computing system comprising a confidence calibration service comprising an AI model for determining a confidence level that an AI action on an object will meet a pre-defined target of action accuracy. A routing orchestrator may be configured to adopt the AI action if the determined confidence level is equal to or above a confidence threshold. A sampling engine may select M out of N AI actions, wherein M <N. A quality assurance workbench may be provided for at least one of: a manual action if the determined confidence level for the AI action is below the confidence threshold; or a manual verification of the M out of the N AI actions. A metric engine may be configured for estimating, upon processing a pool of objects either manually or via an AI action depending on the determined confidence level in relation to the confidence threshold, an error rate in the pool of processed objects based on the verification of all manually performed actions and the M AI actions.

The error rate may be estimated based on a weighted average of an error rate of the verified manual actions, an error rate of the verified M AI actions, and an estimated error rate of non-verified N-M AI actions. A threshold manager may be provided for adjusting the confidence threshold depending on whether an incorrect AI action has been identified among the verified M AI actions. The system may further include a Monte Carlo simulation engine for statistically determining the error rate of the N-M non-verified AI actions.

In some embodiments, the system further includes a logger for logging each confidence threshold adjustment by the threshold manager in an immutable database. The system may be configured to revert to processing all documents manually when a number K of incorrectly processed documents among the M verified automatically processed documents exceeds a pre-defined threshold for the number K. The system may be further configured to adjust the confidence threshold without having to re-train the AI model.

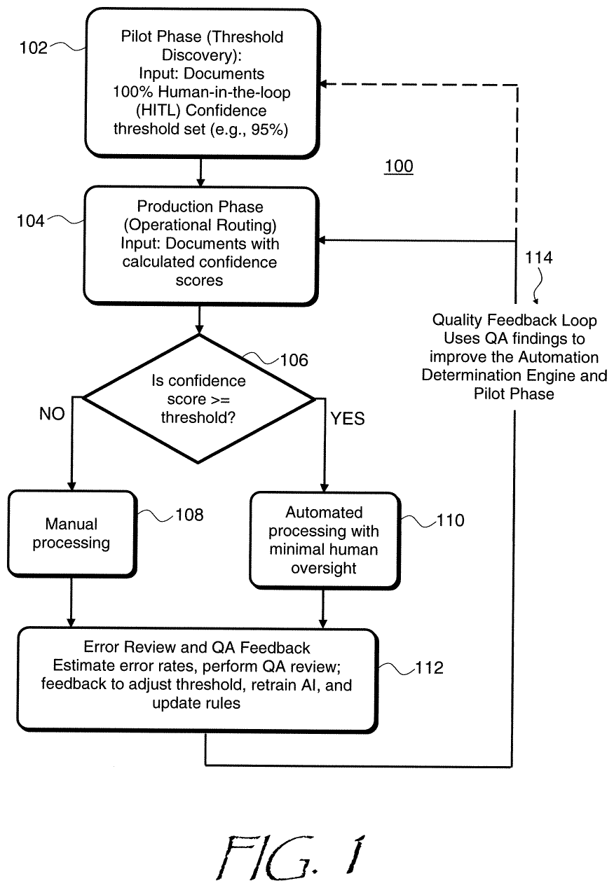

Referring now to FIG. 1, an intelligent document processing (IDP) framework 100 of this disclosure comprises two distinct phases. At a first, pilot phase 102 of implementation, all documents are processed and verified manually or with HITL. During the pilot phase 102, document processing statistics are accumulated to establish appropriate confidence thresholds for subsequent automatic processing. At this stage, business or regulatory accuracy targets are established.

At a second, production phase 104, the previously established confidence threshold is used to begin triaging documents for automated processing. Specifically, documents with a high confidence score are routed (106) to automated processing 110 with minimal or no human oversight, while documents with a sub-threshold confidence score are routed (108) to be processed manually. In this manner, the risks of an erroneous data entry are mitigated, with the documents presenting highest chances of error being processed and verified manually for extra safety and fidelity of the processed data.

Once the documents are processed either manually (108) or automatically (110), an error review 112 is performed. The purpose of the error review 112 is twofold. One is to provide quality feedback 114 to the operational routing phase 104 e.g. for adjusting the confidence threshold. To adjust the confidence threshold, the error review 112 may include an estimation of the achieved error rates. The other is to log the system performance for quality assurance (QA) purposes. QA activity may include performing QA assurance reviews and logging the adjusted confidence threshold. Furthermore, in some embodiments, rules of triaging documents may also be updated. The adaptability of the framework 100 may be provided without having to re-train associated AI models.

If the determined error rates are found to be too high, the framework 100 may revert to the pilot phase 102 where all documents are processed manually as indicated by a dashed arrow in FIG. 1, thereby mitigating risks of accumulating erroneously processed documents. A corresponding record may be made in the QA database. An immutable database, e.g. one based on a blockchain, may be used for this purpose.

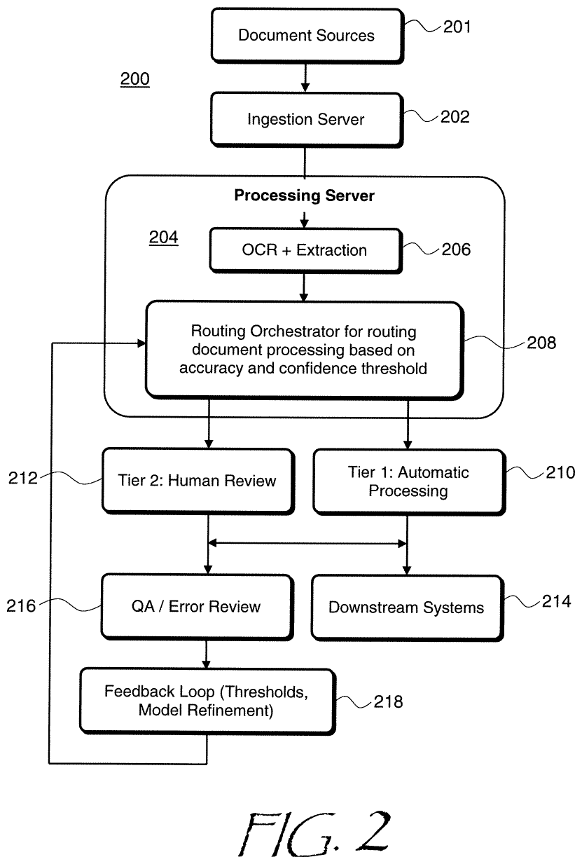

Turning to FIG. 2, a document processing system 200 may implement the IDP framework of FIG. 1. The document processing system 200 includes an ingestion server 202 coupled to a processing server 204. The function of the ingestion server 202 is to receive documents e.g. scanned paper documents, PDF files and filled forms, and web forms from document sources 201 and maintain the ingested documents in a database or a datalake. The function of the processing server 204 is to process and route documents. To that end, the processing server 204 may include an optical character recognition (OCR) and extraction module 206 coupled to a routing orchestrator 208. The function of the OCR and extraction module 206 is to scan incoming documents, convert them to text using an appropriate AI engine, and extract structured information from the documents such as, for example, key-value pairs, document layout templates for future conversions, and the like.

In some embodiments, the OCR and extraction module 206 provides a quality metric associated with OCR of the scanned document. The OCR quality metric may be taken into account when determining the overall confidence level of the document meeting a pre-defined target of processing accuracy. The OCR quality metric may also be accounted for in the determination and/or adjustment of corresponding dynamic confidence thresholds, providing an additional level of assurance by detecting OCR-related anomalies or inconsistencies. The utilization of the OCR quality metric helps in identifying edge cases and systematic errors.

The function of the routing orchestrator 208 is to route document processing based on the confidence level of the document with relation to the confidence threshold, the required accuracy, level of importance of the document, and so on. In some embodiments, the routing orchestrator 208 may be configured to adopt automatic processing of a document if the determined confidence level is equal to or above the confidence threshold. In one scenario, an AI model for automatic document processing operates on the document (e.g. extracts key-value pairs) and provides a confidence level of thereby processed document, or a portion thereof. If the confidence level is equal to or above the confidence threshold, then the results of the automatic processing are taken to be the proper processing results. Alternatively or in addition, the routing orchestrator 208 may direct such document for Tier 1 processing 210, which may include further, separate automatic processing. If the confidence level of a document is below the confidence threshold, the routing orchestrator 208 directs such document for Tier 2 processing 212, which includes human review of the document pre-processed by the AI model, or simply purely manual document processing. The documents may be verified by a QA/Error Review service 216 for providing an overall error rate of the documents. Exemplary methods of calculation of overall error rate will be considered in more detail further below.

The documents processed in Tier 1 210 or Tier 2 212 may be forwarded to downstream systems 214 which utilize the structured information extracted from the processed documents for business purposes, perform statistical analysis, keep records, and the like. The computed overall error rate may be used to further optimize or stabilize the document processing operations by forming a feedback loop 218 for dynamically adjusting the confidence threshold and/or refining AI models. Furthermore, a mechanism may be established to revert to the pilot phase 102 (FIG. 1) with all-manual processing when the overall error rate gets too high.

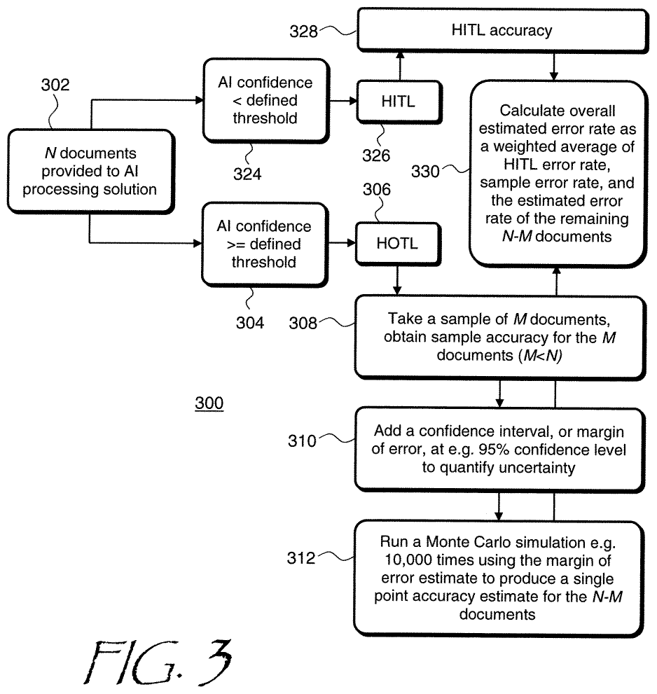

An exemplary procedure for overall error rate estimation will now be described with reference to an error rate estimation flowchart 300 of FIG. 3. N documents may be provided to AI processing solution 302, which may include an AI model trained to classify and evaluate incoming documents and extract structured information such as key-value pairs. The AI model may output a confidence level for each value it determines, including values of individual fields on an official form, confidence of text conversion or document classification, and the like. In some embodiments, an aggregate confidence value for a document may be calculated e.g. as a weighted average of the confidence level of individual determined parameters of the document such as fields, values, text conversion or OCR output, and the document layout. The aggregated confidence value of the document may then be compared to a current confidence threshold.

When the confidence value meets or exceeds the confidence threshold as indicated at 304, a so-called human-on-the-loop or HOTL approach 306 is adopted. In the HOTL approach 306, a sample of M automatically processed documents is selected out of the N automatically processed documents, where M<N. In other words, the M selected documents represent a sub-population of the N automatically processed documents. The M documents are manually verified, and a sample accuracy of the M documents is determined (308) based on the manual verification. The accuracy of the remaining N-M documents, which are not manually verified, may be evaluated in the following manner. A confidence interval, or margin of error, is estimated e.g. at 95% confidence level (310). A Monte Carlo simulation is then run (312) a number of times, e.g. 10,000 times or more, using the margin of error estimate 310 to produce a single point accuracy estimate for the N-M non-verified documents.

When the confidence value is below the confidence threshold as indicated at 324, a HITL approach 326 (as opposed to a HOTL approach 306) is selected. In the HITL approach 326, the documents are manually processed and manually verified. A HITL accuracy 328 is obtained as a result of the human verification of the manually processed documents. Upon accumulation of a pool of documents processed either manually or automatically depending on the determined confidence level in relation to the confidence threshold, an overall error rate may be estimated (330). The overall error rate may be estimated based on a weighted average of: an error rate of the verified manually processed documents; an error rate of the verified M documents; and an error rate of non-verified N-M automatically processed documents estimated by running a Monte Carlo simulation. Thereby obtained overall error rate may be used as basis for a decision to further adjust the confidence threshold and/or for further AI model refinement (FIG. 2; 218).

Following is one example of such processing. For the total population of 5,000 documents, 80% or 4,000 documents are sent to the HITL loop 326 yielding HITL accuracy of 99.5%. Out of remaining N=1,000 documents, M=60 documents are sent through the HOTL loop 306. The Monte Carlo simulation may then be run e.g. 10,000 times at the sample accuracy of 100% and confidence level of 95%, obtaining the estimated error rate of 0.45% for the non-verified N-M =940 documents which is lower than the HITL error rate of 100%−99.5%=0.5%. Herein, the 95% confidence means that if one re-runs the sampling (with replacement of documents) 100 times, then 95 times out of 100 the actual or true error rate for the N-M documents would be within a margin of error, which is also termed confidence interval. The estimated error rate of 0.45% provides a best guess for the N-M documents processing error rate given that observed accuracy rate for M documents processing is 100% and taking into account the associated margin of error at 95% statistical confidence level after running the Monte Carlo simulation. The Monte Carlo simulation may be used to go from the confidence interval (margin of error) to a single point (error rate %) estimate. The observed sample error rate of 0%, or the accuracy of 100%, in verified automatically processed documents means that there is a strong statistical assurance (95% confidence) that the non-verified automatically processed documents are at least [100% observed sample accuracy minus margin of error] accurate.

The Monte Carlo simulation is run (312) only for the unreviewed portion of the documents, not for those already human-reviewed or included in the HOTL document sample. The observed error rate from the HOTL document sample (M documents 308) is used to model potential error in the remaining (non-human-reviewed, non-sample) documents (N-M documents). That simulated error rate may then be combined with the known errors from the human-reviewed documents to get an estimated total error rate for the whole population of the documents. The Monte Carlo simulation, therefore, allows combining information from two distinct groups: documents that are thoroughly reviewed by humans (Human-in-the-Loop, or HITL 326) and documents that are mostly handled by automation (Human-on-the-Loop, or HOTL 306). Every HOTL document is not reviewed; instead, a random sample is taken from this group to check for errors.

The error estimation may begin by looking at the results from the HOTL sample 306. Since this is just a subset, there's always some uncertainty about whether the sample truly reflects the entire HOTL group. The Monte Carlo simulation allows one to model this uncertainty by generating many possible scenarios for what the true error rate in the HOTL group might be, based on our sample results. For each scenario, one may combine the estimated error rate for the HOTL group with the known error rate from the HITL group. This may be done in a way that reflects how many documents are in each group. By repeating this process thousands of times, one can build up a range of possible overall error rates for all documents processed in a day. The end result isn't just a single number but a combination of an average error rate, a measure of accuracy, and a range that shows how much uncertainty there is in the estimate. This approach allows one to make better decisions about the reliability of the document processing automation providing understanding of the risks involved.

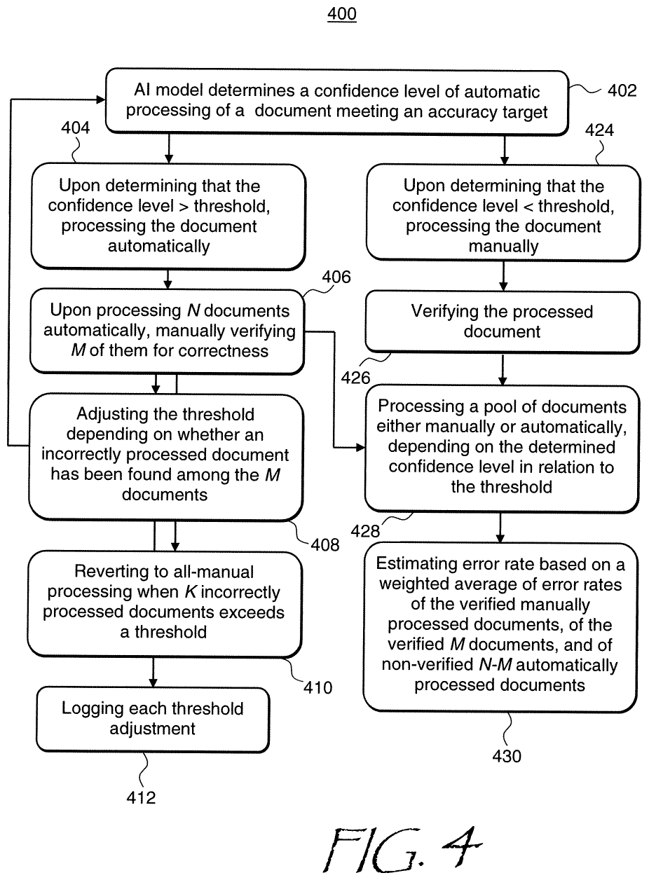

Turning to FIG. 4, a method 400 of this disclosure for document processing includes using an AI model (402) to determine a confidence level that a document, when processed automatically, will meet a pre-defined target of processing accuracy. The confidence level may be determined, for example, by running the AI model to obtain initial processing results, and determining associated confidence levels. The AI model may be the same model as the one used for the document processing, or a dedicated AI model tuned specifically for determining confidence levels. The confidence level may be determined based on aggregating field-level confidence scores of the document into a document-level confidence score using field importance of the field-level confidence scores. The confidence level may take into account an OCR quality metric of converting a document image into text.

If the determined confidence level is equal to or above a confidence threshold of e.g. 95%, automatic processing of the document is adopted (404). Herein, the adoption of automatic processing may include the adoption of the initial processing results, re-running the AI model to obtain full processing results, and/or using a different AI model optimized specifically for the document processing.

Upon automatically processing N documents, M processed documents out of the N processed documents are verified (406) for correctness, where M<N. The M processed documents may be selected randomly. Other methods for selecting M include stratified sampling (e.g. by document type, source, risk level, and so on), systematic sampling (e.g. pick every k^{th} document after a random start), etc.

The confidence threshold may be adjusted (408) depending on whether an incorrectly processed document has been identified among the verified M documents. If, for instance, no incorrectly processed documents have been identified, the confidence threshold may be left without changes or may be lowered, allowing more documents to be processed automatically, which improves processing speed. If an incorrectly processed document has been identified, the confidence threshold may be raised. In both cases, the Monte Carlo simulation may be used as explained above to estimate a probability of an error in the non-verified N-M documents and adjust the confidence threshold accordingly.

If the determined confidence level is below the confidence threshold, the document is processed manually (424). The results of the manual document processing may be verified manually (426) to obtain an estimate of an error rate of manual document processing. Once a pool of documents (428) has been processed either manually or automatically depending on the determined confidence level in relation to the confidence threshold, an overall error rate in the pool of processed documents may be estimated (430) based on the verification of all manually processed documents and the M automatically processed documents. As explained above, the overall error rate may be estimated based on a weighted average of the following error rates: an error rate of the verified (426) manually processed documents; an error rate of the verified M automatically processed documents (406); and an estimated error rate of non-verified N-M automatically processed documents. The error rate of N-M non-verified automatically processed documents may be determined statistically by running a Monte Carlo simulation. The determined overall error rate may be used to calculate a new value of the confidence threshold. Each confidence threshold adjustment may be logged (412) in an immutable database.

The method 400 may include statistically determining a probability that a next document processed after adjusting the confidence threshold will not meet the pre-defined target of processing accuracy. If the probability is too high, the method 400 may include raising the threshold or, in some cases, reverting to 100% manual processing of the documents (410). In some embodiments, the reverting to processing all documents manually may occur when a number K of incorrectly processed documents among the M verified documents exceeds a pre-defined threshold. This provides a “hand brake” for the automated processing when the error rates become unacceptably high. The number K may be selected based on a business-dependent “unacceptable error rate” and an associated confidence level. Alternatively, a binomial distribution may be used to compute a probability of detecting up to K errors in a sample of documents.

The method 400 may be applicable to not only the banking industry but rather to any industrial segment requiring some AI-enabled action such as e.g. document extraction, transactions processing, fraud detection, image/signal classification, healthcare diagnostics, content moderation, manufacturing quality assurance, and other areas where a document (e.g. a file, an image, a text) may be processed manually or automatically. The method 400 provides a framework for such automated processing while establishing adaptive control of the relevant confidence thresholds and providing a mechanism for the “hand brake”, as well as verifiable records of achieved error rates.

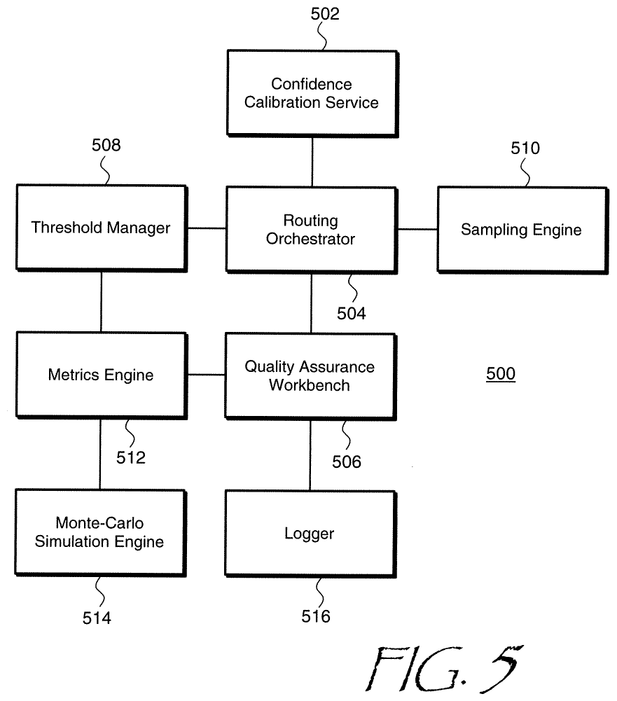

Referring to FIG. 5, a document processing computing system 500 of this disclosure may be used to implement the method 400 of FIG. 4. The document processing computing system 500 includes a confidence calibration service 502 comprising an AI model for determining a confidence level that a document, when processed automatically, will meet a pre-defined target of processing accuracy. A routing orchestrator 504 may be configured to adopt automatic processing of the document if the confidence level determined by the confidence calibration service 502, is equal to or above a confidence threshold. A quality assurance workbench 506 may be configured for a manual verification of M automatically processed documents out of N automatically processed documents for correctness, where M<N. The quality assurance workbench 506 may be configured to select manual processing of the document upon determining that the confidence level is below the confidence threshold. A threshold manager 508 may be configured to adjust the confidence threshold depending on whether an incorrectly processed document has been identified among the verified M documents, as explained above with reference to FIG. 4.

In some embodiments, the system 500 may further include a sampling engine 510 for selecting the M out of the N automatically processed documents for manual verification of the correctness of the automatic processing. A metrics engine 512 may be provided for estimating, upon processing a pool of documents either manually or automatically depending on the determined confidence level in relation to the confidence threshold, an error rate in the pool of processed documents based on the verification of all manually processed documents and the M automatically processed documents. As explained above, the overall error rate may be based on a weighted average of an error rate of the verified manually processed documents, an error rate of the verified M documents, and an estimated error rate of N-M non-verified automatically processed documents.

The system 500 may further include a Monte Carlo simulation engine 514 for determining the error rate of N-M non-verified automatically processed documents by running a Monte Carlo resampling simulation. The Monte Carlo simulation engine 514 may be further configured to statistically determine a probability that a next document processed after adjusting the confidence threshold will still not meet the pre-defined target of processing accuracy. A logger 516 may be provided for logging each confidence threshold adjustment by the threshold manager 508 in an immutable database, not shown for brevity. The system 500 may be further configured to revert to processing all documents manually (i.e. to revert to the pilot phase 102 in FIG. 1) when a number K of incorrectly processed documents among the M verified documents exceeds a pre-defined threshold for the number K.

The system 500 of FIG. 5 may be implemented in a computing system. The computing system may include non-transitory computer-readable medium comprising instructions that, when executed by one or more processors of a document processing computer system, cause the one or more processors to implement the method 400 of FIG. 4. For example, an AI model may be used (402) to determine a confidence level that a document, when processed automatically, will meet a pre-defined target of processing accuracy. If the determined confidence level is equal to or above a confidence threshold, the system 500 adopts automatic processing (404) of the document. Upon automatically processing N documents, the system 500 manually verifies (406) M automatically processed documents out of the N automatically processed documents. The system 500 then adjusts (408) the confidence threshold depending on whether an incorrectly processed document has been identified among the verified M documents.

The system and method disclosed herein generally improve speed, efficiency, accuracy, and reliability of a computer system for document processing. The speed is improved because not all automatically processed documents are verified manually, the error-rate of non-verified documents being evaluated via a Monte Carlo simulation. The efficiency is improved because the confidence threshold for automatic document processing is constantly monitored and adjusted depending on the current evaluated overall error rate. The accuracy is improved because the Monte Carlo simulation relied upon when integrating HITL and HOTL accuracy into a composite key performance indicator (KPI) ensures a statistically lower overall error rate as compared to existing methods. The reliability and veracity are improved due to the mechanism provided to raise the confidence threshold when the overall error rate becomes too high, and to log each confidence threshold adjustment decision for audit purposes.

Furthermore, the systems and methods disclosed herein may be generalized beyond mere automatic document processing. A similar framework to the one described with reference to FIGS. 1-5 above may be applied to a plethora of other AI automation areas known or unknown, including without limitation fraud detection, image classification, signal classification, healthcare diagnostics, content moderation, and manufacturing quality assurance (QA). Any activity including an AI action on an object, the object being a document, an image, a signal, a financial transaction, a healthcare chart, a web content, or QA testing parameters, may benefit from the framework, methods, and systems disclosed herein.

For example, referring back to FIG. 5, the system 500 may be generalized to operate as an automatic AI-enabled decision-making system where the confidence calibration service 502 includes an AI model for determining a confidence level that an AI action on an object will meet a pre-defined target of action accuracy. The routing orchestrator 504 may be configured for adopting the AI action if the determined confidence level is equal to or above a corresponding confidence threshold. The sampling engine 510 may be configured for selecting M out of the N AI actions, where M<N. The quality assurance workbench 506 may be configured for a manual action if the determined confidence level for the AI action is below the confidence threshold, and/or a manual verification of the M out of N AI actions. This is similar to the previously considered case of AI-assisted document processing.

The metrics engine 512 may be configured for estimating, upon processing a pool of objects either manually or via an AI action depending on the determined confidence level in relation to the confidence threshold, an error rate in the pool of processed objects based on the verification of all manually performed actions and the M AI actions. Similar to the previous document processing examples, the overall error rate may be estimated based on a weighted average of an error rate of the verified manual actions, an error rate of the verified M AI actions, and an error rate of non-verified N-M AI actions estimated via a corresponding Monte Carlo simulation. The threshold manager 508 may be configured for adjusting the confidence threshold depending on whether an incorrect or imprecise AI action has been identified among the verified M AI actions.

The Monte Carlo simulation engine 514 may be configured to statistically determine the error rate of the N-M non-verified AI actions. The Monte Carlo simulation engine 514 may be further configured to statistically determine a probability that a next object processed after adjusting the confidence threshold will still not meet the pre-defined target of action accuracy. The logger 516 may be configured for logging each confidence threshold adjustment by the threshold manager in an immutable database. Finally, similar to the document processing example considered above, the system 500 may be configured to revert to manual actions when a number K of incorrect AI actions among the M verified AI actions exceeds a pre-defined threshold for the number K. In applications where the client explicitly restricted the use of the client data, the confidence threshold may be adjusted without having to re-train the AI model on the client data.

The systems and methods disclosed herein allow a significant performance improvement of corresponding computer systems. For example, a computer system for processing documents is improved because it allows an adaptive, traceable, and scalable documents processing with business-defined accuracy targets distinct from model confidence thresholds. A computer system for fraud detection is similarly improved. The fraud detection may be scaled in a predictable and traceable manner without having to rely on human verification which impedes scalability. Similar improvements are envisioned in a computer system for image or signal classification, an automated diagnostic computer system, a content moderation computer system, and the like. The framework disclosed herein is a domain-agnostic, two-tier governance framework for safe and auditable AI automation. Confidence-based routing of AI outputs into HITL/HOTL combined with Monte Carlo simulation allows one to convert sample statistics into a single-point, system-wide accuracy estimate, as well as provide a scalable, auditable, and controllable solution to AI automation in a variety of applications.

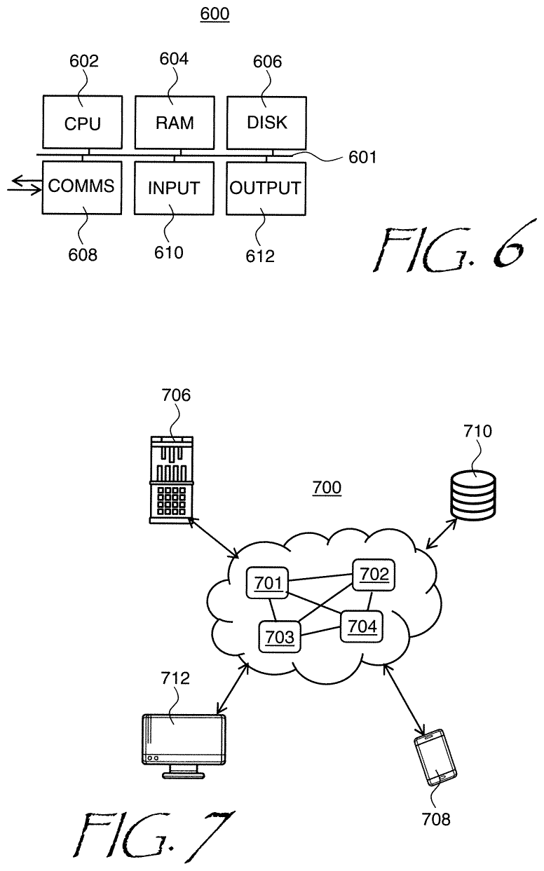

Embodiments of this disclosure may be implemented in a computing system. Referring to FIG. 6 for a non-limiting illustrative example, a computing system 600 may be configured to implement the method 400 of FIG. 4, the system 500 of FIG. 5, as well as other methods, procedures, and systems disclosed herein. The computing system 600 may include at least one computer processor (CPU) 602, non-persistent storage 604 e.g. random access memory (RAM), cache memory, persistent storage 606 such as flash memory, a hard drive (DISK), an optical drive such as a compact disk (CD) drive or a digital versatile disk (DVD) drive, etc. The computer processor 602 may include integrated circuitry for processing instructions, which may be stored on the non-persistent 604 or persistent 606 storage. The computer processor 602 may include one or more cores, mini-cores, or micro-cores.

The computing system 600 may further include a communication interface 608 (COMMS) such as wireless interface, infrared interface, network interface, optical interface, and other elements and functionalities. At least one input device 610 (INPUT) such as a keyboard, a mouse, a touchscreen, a touchpad, a microphone, an electronic pen, or any other type of input device, may be provided. The communication interface 608 may include an integrated circuit for connecting the computing system 600 to a network e.g. a local area network (LAN), a wide area network (WAN) such as the Internet, a mobile network, or any other type of network) and/or to another device, such as a computer or a smartphone.

The computing system 600 may further include at least one output device 612 (OUTPUT) such as a monitor screen e.g., a liquid crystal display (LCD), a plasma display, a touchscreen, a cathode ray tube (CRT) monitor, a projector or another display device, a printer, an external storage, or any other output device as the case may be. The computer processor 602, the non-persistent storage 604, the persistent storage 606, the communication interface 608, the input device 610, and the output device 612 may communicate with one another via a dedicated bus 601. In some embodiments, the input 610 and output 612 devices may be remotely connected to the computer processor 602, the non-persistent storage 604, and/or the persistent storage 606. Many different types of computing systems, architectures, input/output devices, and communication configurations may be used in embodiments of this disclosure.

Software instructions in form of computer readable program code to perform embodiments of this disclosure may be stored, in whole or in part, temporarily or permanently, on a non-transitory computer readable medium of the persistent storage 606 such as flash memory, a CD, a DVD, a storage device, a diskette, a tape, physical memory, or any other suitable computer readable storage medium. The software instructions may correspond to computer readable program code that, when executed by the computer processor 602, is configured to perform one or more functions disclosed herein.

The computing system 600 of FIG. 6 may be connected to or be a part of a network. Referring to FIG. 7 for a non-limiting illustrative example, a network 700 may include multiple nodes, e.g. first 701, second 702, third 703 and fourth 704 nodes. More or less nodes may be provided. Each node 701-704 may be based on a computing system such as the computing system 600 of FIG. 6 described above. By way of a non-limiting illustrative example, embodiments of this disclosure may be implemented on a node of a distributed system that is connected to other nodes. By way of another non-limiting illustrative example, embodiments of this disclosure may be implemented on a distributed computing system having multiple nodes, where each portion of the computing system may be located on a different node. Furthermore, one or more elements of the aforementioned computing system may be located at a remote location and connected to the other elements over a network. The nodes 701-704 of the network 700 may be configured to provide services disclosed herein to clients via client devices such as a user's computer 706 or a user's mobile device 708.

The nodes 701-704 may be part of a cloud computing system. The nodes 701-704 may include functionality to receive requests from the client device and transmit responses to the client device. The client device may include a computing system such as the computing system 600 of FIG. 6 and, in some cases, may perform all or a portion of one or more embodiments disclosed herein. The network 700 of FIG. 7 may further include other service-specific devices and systems, such as a data repository 710, an information display or dashboard 712, etc.

Although not shown in FIG. 7, at least some of the nodes 701-704 may correspond to a blade in a server chassis connected to other one(s) of the nodes 701-704 via a backplane. By way of a non-limiting example, the node(s) may correspond to a server in a data center. By way of another non-limiting example, the node(s) may correspond to a computer processor or micro-core of a computer processor with shared memory and/or resources.

The computing system 600 of FIG. 6 or the group of computing systems or nodes 701-704 of the network 700 of FIG. 7 may include functionality to perform a variety of operations, procedures, and/or methods disclosed herein. By way of a non-limiting illustrative example, the computing system(s) disclosed herein may perform communication between processes on the same or different system. A variety of mechanisms employing some form of active or passive communication may facilitate the data exchange between processes on a same device, or on different devices. Examples illustrative of these inter-process communications include, but are not limited to, the implementation of a file, a signal, a socket, a message queue, a semaphore, a pipeline, shared memory, message passing, and a memory-mapped file. Other techniques may be used to share data between processes described herein. The processes may be part of the same or different application and may execute on the same or different computing systems.

A computing system performing one or more embodiments of this disclosure may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchscreen, a touchpad, a keyboard, a mouse, or any other input device 610 (FIG. 6) as the case may be. In response to selecting a particular item, information regarding the particular item may be obtained from the persistent 606 or non-persistent 604 storage by the computer processor 602. Upon selection of the item by the user, the contents of the obtained data regarding the particular item may be displayed on the user device in response to the user's selection.

By way of another example, a request to obtain data regarding the particular item may be sent to a server operably connected to the user device through a network such as the network 700 of FIG. 7. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

The computing system 600 of FIG. 6 may implement and/or be connected to a data repository. For example, in FIG. 7, any of the nodes 701-704 and/or the computer 706 may be connected to the data repository 710 through the network 700. One type of data repository is a database. A database is a collection of information configured for ease of data retrieval, modification, re-organization, and deletion. A Database Management System (DBMS) may be used. The DBMS is a software application that provides an interface for users to define, create, query, update, or administer databases. Another example type of a data repository is a datalake.

The computing system 600 of FIG. 6 may be configured to include functionality for presenting raw and/or processed data, such as results of comparisons or other processing. For example, data may be presented through a user interface provided by a computing device. The user interface may include a GUI that displays information on a display device, such as the display 712, a computer monitor or a touchscreen on a handheld computer device, etc. The GUI may include various GUI widgets that organize what data is shown as well as how data is presented to a user. Furthermore, the GUI may present data directly to the user, e.g., data presented as actual data values through text or rendered by the computing device into a visual representation of the data, such as through visualizing a data model.

The present disclosure is not to be limited in scope by the specific embodiments described herein. Other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for document processing, the method comprising:
using an AI model to determine a confidence level that a document, when processed automatically, will meet a pre-defined target of processing accuracy;
if the determined confidence level is equal to or above a confidence threshold, adopting automatic processing of the document;
upon automatically processing N documents, manually verifying M automatically processed documents out of the N automatically processed documents, wherein M<N; and
adjusting the confidence threshold depending on whether an incorrectly processed document has been identified among the verified M documents.

2. The method of claim 1, further comprising processing the document manually upon determining that the confidence level is below the confidence threshold.

3. The method of claim 1, further comprising:
processing a pool of documents either manually or automatically, depending on the determined confidence level in relation to the confidence threshold; and
estimating an error rate in the pool of processed documents based on the verification of all manually processed documents and the M automatically processed documents.

4. The method of claim 3, wherein the error rate is estimated based on a weighted average of an error rate of the verified manually processed documents, an error rate of the verified M automatically processed documents, and an error rate of non-verified N-M automatically processed documents, which is estimated statistically by running a Monte Carlo simulation.

5. The method of claim 1, wherein at least one of:
the determined confidence level is based at least in part on a quality metric associated with optical character recognition of the document; or
the method further comprises statistically determining a probability that a next document processed after adjusting the confidence threshold will not meet the pre-defined target of processing accuracy.

6. The method of claim 1, further comprising reverting to processing all documents manually when a number K of incorrectly processed documents among the M verified documents exceeds a pre-defined threshold.

7. The method of claim 1, further comprising logging each confidence threshold adjustment in an immutable database.

8. The method of claim 1, wherein the confidence threshold is adjusted without re-training the AI model.

9. A document processing computing system comprising:
a confidence calibration service comprising an artificial intelligence (AI) model for determining a confidence level that a document, when processed automatically, will meet a pre-defined target of processing accuracy;
a routing orchestrator for adopting automatic processing of the document if the determined confidence level is equal to or above a confidence threshold;
a quality assurance workbench for a manual verification of M automatically processed documents out of N automatically processed documents, wherein M<N; and
a threshold manager for adjusting the confidence threshold depending on whether an incorrectly processed document has been identified among the verified M documents.

10. The system of claim 9, wherein the quality assurance workbench is configured to select manual processing of the document upon determining that the confidence level is below the confidence threshold.

11. The system of claim 9, further comprising:
a sampling engine for selecting the M out of the N automatically processed documents; and
a metrics engine for estimating, upon processing a pool of documents either manually or automatically depending on the determined confidence level in relation to the confidence threshold, an error rate in the pool of processed documents based on the verification of all manually processed documents and the M automatically processed documents;
wherein the error rate is estimated based on a weighted average of an error rate of the verified manually processed documents, an error rate of the verified M automatically processed documents, and an estimated error rate of non-verified N-M automatically processed documents.

12. The system of claim 11, further comprising a Monte Carlo simulation engine for determining the error rate of the N-M non-verified automatically processed documents;
wherein the Monte Carlo simulation engine is configured to statistically determine a probability that a next document processed after adjusting the confidence threshold will still not meet the pre-defined target of processing accuracy.

13. The system of claim 9, further comprising a logger for logging each confidence threshold adjustment by the threshold manager in an immutable database.

14. The system of claim 9, wherein the system is configured to revert to processing all documents manually when a number K of incorrectly processed documents among the M verified automatically processed documents exceeds a pre-defined threshold for the number K.

15. The system of claim 9, configured to adjust the confidence threshold without having to re-train the AI model.

16. An automatic decision-making computing system comprising:
a confidence calibration service comprising an artificial intelligence (AI) model for determining a confidence level that an AI action on an object will meet a pre-defined target of action accuracy;
a routing orchestrator for adopting the AI action if the determined confidence level is equal to or above a confidence threshold;
a sampling engine for selecting M out of N AI actions, wherein M <N;
a quality assurance workbench for at least one of: a manual action if the determined confidence level for the AI action is below the confidence threshold; or a manual verification of the M out of the N AI actions;
a metrics engine for estimating, upon processing a pool of objects either manually or via an AI action depending on the determined confidence level in relation to the confidence threshold, an error rate in the pool of processed objects based on the verification of all manually performed actions and the M AI actions, wherein the error rate is estimated based on a weighted average of an error rate of the verified manual actions, an error rate of the verified M AI actions, and an estimated error rate of non-verified N-M AI actions; and
a threshold manager for adjusting the confidence threshold depending on whether an incorrect AI action has been identified among the verified M AI actions.

17. The system of claim 16, further comprising a Monte Carlo simulation engine for statistically determining the error rate of the N-M non-verified AI actions.

18. The system of claim 16, wherein the action comprises at least one of: document extraction; fraud detection; image classification; signal classification; healthcare diagnostics; content moderation; or manufacturing quality assurance.

19. The system of claim 16, further comprising a logger for logging each confidence threshold adjustment by the threshold manager in an immutable database;
wherein the system is further configured to revert to manual actions when a number K of incorrect AI actions among the M verified AI actions exceeds a pre-defined threshold for the number K.

20. The system of claim 16, configured to adjust the confidence threshold without having to re-train the AI model.
